(19) United States
(12) Patent Application Publication
(10) Pub. No.: US 2005/0111777 A1
(43) Pub. Date: May 26, 2005

(54) Monolithic integrated photonic interconnect device

(76) Inventors: Vincent E. Stenger, West Covina, CA (US); Fred R. Beyette JR., Cincinnati, OH (US)

Correspondence Address: FROST BROWN TODD, LLC, 2200 PNC CENTER, 201 E. FIFTH STREET, CINCINNATI, OH, 45202, US

(21) Appl. No.: 10/965,366

(22) Filed: Oct. 14, 2004

Related U.S. Application Data
(60) Provisional application No. 60/510,948, filed on Oct. 14, 2003.

(51) Int. Cl. G02B 6/12

(52) U.S. Cl. 385/14

(57) ABSTRACT

The present invention relates to a monolithic integrated photonic interconnect device which includes an optical layer having an input end and an output end, capable of conveying light between the input end and the output end, a semiconductor substrate layer comprising an integrated optical-electronic device and electronic circuitry operationally connected to the integrated optical-electronic device, and an optical coupling device disposed between, and operationally connected to, the optical layer and the optical-electronic device. In one embodiment of the interconnect device, the integrated optical-electronic device is able to generate light, detect light, amplify light or otherwise modulate amplitude or phase of light. In another embodiment of the interconnect device, the integrated optical-electronic device is a traveling wave type photodetector. In a further embodiment of the interconnect device, the optical coupling device is an asymmetric multimode interference coupler. In another embodiment of the interconnect device, the optical layer includes a first single mode transport channel wave guide portion operationally connected to the input end of the optical layer and the optical coupling device and a second single mode transport channel wave guide portion operationally connected to the output end of the optical layer and the optical coupling device. The first and second single mode channel wave guide portions and the optical coupling device have substantially the same layer dimensions.

### CROSS REFERENCE TO RELATED APPLICATIONS

This application claims the benefit of U.S. provisional Patent Application No. 60/510,948, filed Oct. 14, 2003, the contents of which are hereby incorporated by reference as if stated herein.

### TECHNICAL FIELD

The present invention relates to The present invention relates to a monolithic integrated photonic interconnect devices and methods of making and using such devices.

### BACKGROUND OF THE INVENTION

Integration of optical components and electronics for networking, sensing, and displays has been an ongoing process for many years. Much success has been met in the area of long distance fiber optic telecommunications, though discrete electro-optical, and specialty electronic component packaging in current fiber optic technologies are costly. Since long distance optical links serve many users, the cost can be justified. However, as optical networks advance closer to the end user, such as in metropolitan and local area networks, the cost of discrete packaging of bulk optical and electronic components becomes prohibitive.

Monolithic chip integration of optics and electronics at the transmitting and receiving ends is an enabler for low cost, high performance, local area optical networking and distributed computing. The ultimate speed of a computer system, whether it is a single processor system or a distributed network of computers, is typically limited by the rate at which information processing blocks can be clocked, synchronized, and linked to other processing blocks. Optical links have inherently higher bandwidth than electrical ones by virtue of high optical carrier frequencies and low loss guide technology. What is sought in metropolitan, local, and board/chip level optical links is an optical inter-connect technology that is compact, economical, and that can be readily incorporated into existing electronic chip processes. With high yield, low cost processes, optical links at the computer board and chip levels can be made feasible. Integrated optic wave guide technologies have been proposed to replace metal electrical data paths, which suffer from signal propagation delays, interference, noise, and loss effects. This is especially an issue for high-speed clock signals, which usually represent the highest frequencies of the computer or communication system. While generally adequate, prior attempts to realize compact, high speed, economical and efficient coupling between optical and electrical signals and in optical routing have not met industry and end user expectations.

### SUMMARY OF THE INVENTION

The present invention relates to a monolithic integrated photonic interconnect device which includes an optical layer having an input end and an output end, capable of conveying light between the input end and the output end, a semiconductor substrate layer comprising an integrated optical-electronic device and electronic circuitry operationally connected to the integrated optical-electronic device, and an optical coupling device disposed between, and operationally connected to, the optical layer and the optical-electronic device.

In one embodiment of the interconnect device, the integrated optical-electronic device is able to generate light, detect light, amplify light or otherwise modulate amplitude or phase of light.

In another embodiment of the interconnect device, the integrated optical-electronic device is a traveling wave type photodetector.

In a further embodiment of the interconnect device, the optical coupling device is an asymmetric multimode interference coupler.

In another embodiment of the interconnect device, the optical layer includes a first single mode transport channel wave guide portion operationally connected to the input end of the optical layer and the optical coupling device and a second single mode transport channel wave guide portion operationally connected to the output end of the optical layer and the optical coupling device. The first and second single mode channel wave guide portions and the optical coupling device have substantially the same layer dimensions.

### BRIEF DESCRIPTION OF THE DRAWINGS

This invention, as defined in the claims, can be better understood with reference to the following drawings:

FIG. 1a is a pictorial representation of an integrated circuit embodying the present invention and FIG. 1b is a cross-sectional diagram of the integrated circuit of FIG. 1a, depicting an optical wave guide coupled semiconductor device utilizing the asymmetric multimode interference coupling structure in accordance with an exemplary embodiment of the present invention.

FIGS. 2a and 2b are diagrams illustrating two alternate embodiments of the asymmetric multimode interference coupling structure of FIG. 1b, each with different levels of lateral optical mode confinement for the asymmetric multimode interference structure.

FIG. 3a to 3c are diagrams illustrating top, side and end views of the asymmetric multimode interference coupling structure of FIG. 1b, showing the asymmetric multimode interference coupling structure integrated with an electronic chip to realize the high speed optical receiver/tap or optical modulation function.

FIG. 4 is a cross sectional diagram of the integrated circuit of FIG. 1a, showing the asymmetric multimode interference structure in an optical to electrical coupling mode where the spacing between the optical guide and the electronic layer is increased in accordance with an exemplary embodiment of the present invention.

FIG. 5 is a cross sectional diagram of the integrated circuit of FIG. 1a, showing the asymmetric multimode interference structure in an electrical to optical coupling mode whereby the optical output light is modulated by an electrical signal.

FIG. 6 is a logical extension of the integrated circuit of FIG. 1b, whereby the coupling between optical and electrical layers is localized and enhanced through the use of an optically resonant substrate layer in accordance with an exemplary embodiment of the present invention.

FIG. 7 is a cross sectional diagram of the integrated circuit of FIG. 1a, showing specific dimension rules for the asymmetric multimode interference structure in an optical to optical coupling mode whereby different optical layers can be connected over a relatively short distance in accordance with an exemplary embodiment of the present invention.

FIG. 8a to 8c are front cross-sectional view diagrams of the asymmetric multimode interference structure of the integrated circuit of FIG. 1a, showing three different designs for optical tap signal equalization over a series cascade of tap/modulator devices, namely (a) fixed spatial locations, (b) segmented couplers with terminating taps, and (c) fixed coupler segment lengths for non-terminating taps.

FIG. 9 is a front cross-sectional view diagram of the asymmetric multimode interference structure of the integrated circuit of FIG. 1a, showing a wavelength selective scheme based on integration of the asymmetric multimode interference structure with wave guide gratings for the purpose of wavelength division multiplexing or demultiplexing in accordance with an exemplary embodiment of the present invention.

FIG. 10a to 10f is a series of front cross sectional diagrams of the asymmetric multimode interference coupling structure of the integrated circuit of FIG. 2a, illustrating the manufacturing process steps to fabricate the asymmetric multimode interference structure in a demonstration of reduction to practice for an asymmetric multimode wave guide coupler device that is in accordance with an exemplary embodiment of the present invention.

In the following description of the illustrated embodiments, references are made to the accompanying drawings, which form a part hereof, and in which is shown by way of illustration various embodiments in which the invention may be practiced. It is to be understood that other embodiments may be utilized, and structural and functional changes may be made without departing from the scope of the present invention.

### DETAILED DESCRIPTION OF THE INVENTION

It must be noted that as used herein and in the appended claims, the singular forms “a”, “and”, and “the” include plural referents unless the context clearly dictates otherwise. Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

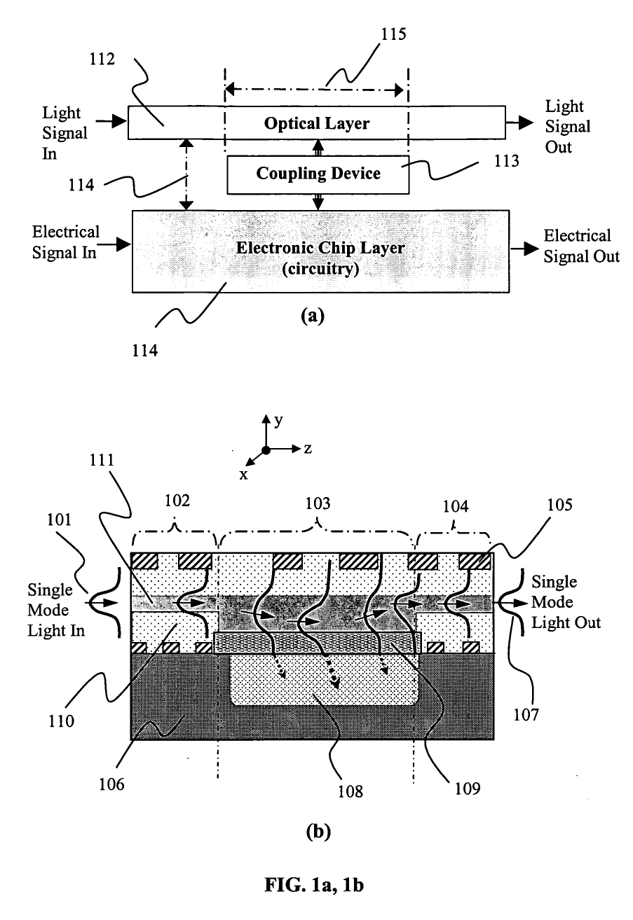

Referring to FIG. 1a, there is shown a pictorial representation of an integrated circuit embodying the present invention. The purpose of the invention is to allow a large range of either optical to electrical, or electrical to optical coupling 113 for a large range of optical to electrical layer spacing 114, and in as short a distance 115 as possible to maximize integrated optical-electronic circuit lateral and vertical density.

Referring now to FIG. 1b, there is shown a cross-sectional diagram of the integrated circuit of FIG. 1a, including a compact optical to electrical coupler device utilizing the asymmetric multimode interference structure 103 of one preferred embodiment of the present invention. The optical to electrical coupler includes a single vertical mode optical wave guide 111 situated above an optical-electronic substrate 106 having a top surface, integrated photodetector or electrically modulated optical absorption device 108 (optical-electrical conversion device) embedded in substrate 106 and having a top surface substantially coplanar with the substrate top surface. An asymmetric offset multimode optical-electrical wave guide coupler section 103 consists of offset thickened multimode wave guide and spacer layers situated between the single mode wave guide and the substrate integrated optical-electronic conversion device 108 for the purpose of coupling light between the single vertical mode optical wave guide 111 and the electronic circuitry. Referring to the figure, the optical tap operation of the asymmetric multimode coupling structure is as follows:

Use of single mode light transport to (102) and from (104) the asymmetric multimode coupling structure 103 minimizes the evanescent field profile so that there is little scatter and absorption loss to the electrical circuitry in the region of the substrate surface (not shown). As the input single mode light 101 passes through the single mode guide section 102 to the offset multimode guide region 103, the first and second order optical modes of the asymmetric multimode optical wave guide section 103 are approximately equally excited. Interference of the modes causes the light profile to oscillate downward toward the optical-electrical circuit substrate 106, where strong coupling through the spacer layer 109 to the substrate integrated optical-electronic conversion device 108 can then occur. The provision for the spacer layer 109 allows for variability in the electrical circuit landscape and to allow flexibility in the spacing between the single mode optical wave guide and the electronic circuitry. Preferably the optical-electronic conversion device 108 and other electrical circuitry fabricated on integrated circuit substrate 106 are CMOS (complementary metal oxide semiconductor) or hybridized Bipolar-CMOS (BiCMOS) circuitry. The spacer layer 109 may be a homogeneous layer material, or a multi-layer of various materials to achieve a desired coupling behavior, such as for wavelength selectivity, or for optical polarization sensitivity control.

After some unit length 103, the light profile oscillates back by multimode interference (MMI) and couples back into the upper single mode guide layer 111, causing very little excess optical loss to occur as it exits the entire coupling structure via a matching single mode output optical guide section 104 identical to the input transport guide section 102. Excess optical loss is defined here as the fraction of optical signal that is not recovered by the output guide section 104 nor coupled into the substrate for conversion into an electrical signal.

The fraction of coupling of light through the spacer 109 to the substrate and optical-electrical conversion device 108 can be controlled by any of several methods. To increase optical-electrical coupling, the multimode tap section length can be increased by integer multiples of the unit coupling length of the optical multimode section 103. The polarization of the input light 101 can also be adjusted to achieve a desired coupling. To reduce the amount of coupling, a variable thickness cladding, or other low effective optical index isolation layer can be inserted between the multimode coupling layer and the electrical-optical substrate and conversion device 108, as an extension of the spacer layer 109.

The key features of the optical to electrical coupling device of FIG. 1b are summarized as follows:
i. Single mode transport for lower scattering loss. This also allows integration of wavelength multiplexing elements.
ii. Extremely compact layout. Correct choice of materials results in devices 15-25 micrometers or less in unit length.
iii. Adjustable optical coupling to the integrated optical-electrical conversion device 108 via tap length, polarization, isolation layer thickness, and spacer layer design (wavelength selectivity).
iv. Multimode interference length (increase by integer multiples of unit length)
v. Input light polarization
vi. Isolation layer thickness (in place of or part of spacer layer 109)
vii. Spacer layer thickness and design (i.e. multi-layer interference designs)
viii. Low excess loss, due to optical field mode matching at the exit guide.
ix. The structure can be shown to be readily integrated with high speed, traveling wave type photodetector and optical modulator devices. This ensures that the optical to electrical conversion gain-bandwidth performance is scalable and not time constant limited by lumped resistive capacitive and/or inductive parasitic elements, regardless of the length of the device.

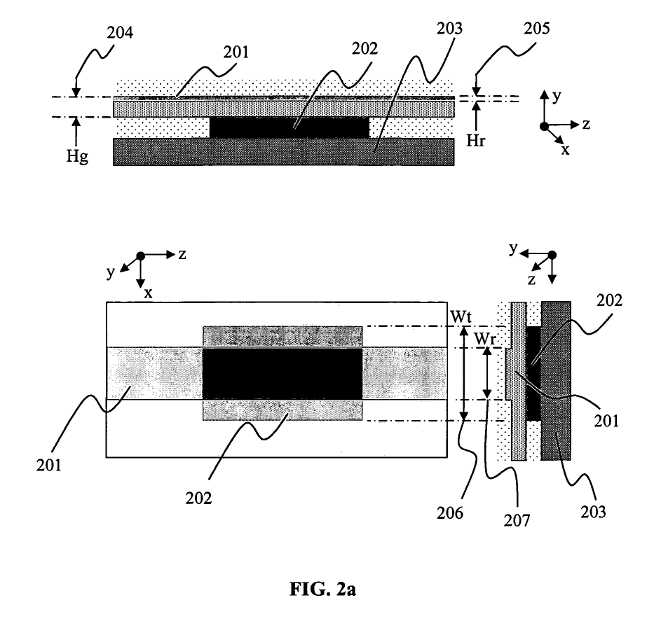

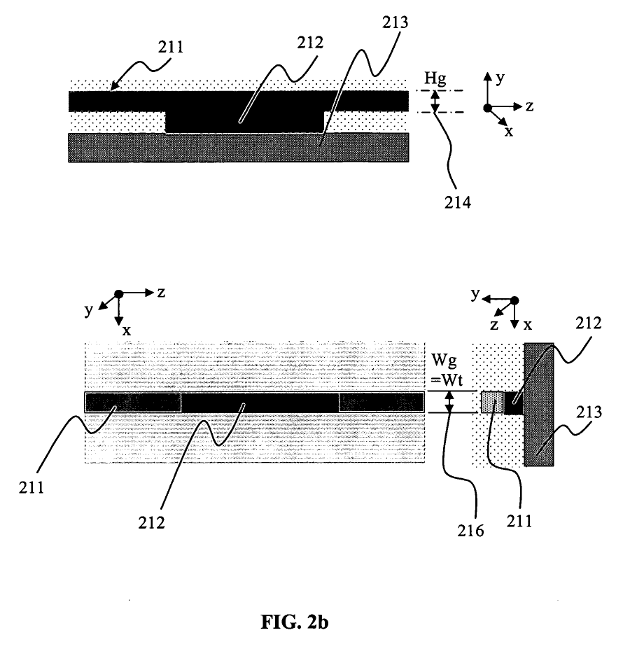

Referring now to FIGS. 2a and 2b, diagrams are given illustrating two levels of lateral optical mode confinement for the asymmetric multimode interference structure in accordance with an exemplary embodiment of the present invention. These two diagrams represent low (FIG. 2a) and high (FIG. 2b) lateral optical mode confinement cases. The lateral confinement is determined by the etch depth 205 of the single mode wave guide 201 commonly referred to as a ridge wave guide. Alternatively, the confinement could be achieved by any of a number of other means well known by one skilled in the art. The larger lateral width 206 of the asymmetric multimode coupling layer 202 for the FIG. 2a allows the large lateral evanescent portion of the wave guide light in loosely laterally confined guide 201 to travel through approximately the same vertical multimode path as the light in the single mode transport guide core region. This adjustment is critical to achieve low excess optical loss of the device when low confinement optical guides are employed. The high lateral confinement single mode wave guide structure 211 of FIG. 2b, commonly referred to as a channel wave guide, benefits from compact lateral dimensions, and is ideal for application to high-density CMOS electrical circuits. In FIG. 2b, the multimode coupling section 212 width is equal in width to the single mode transport optical wave guide 211 .

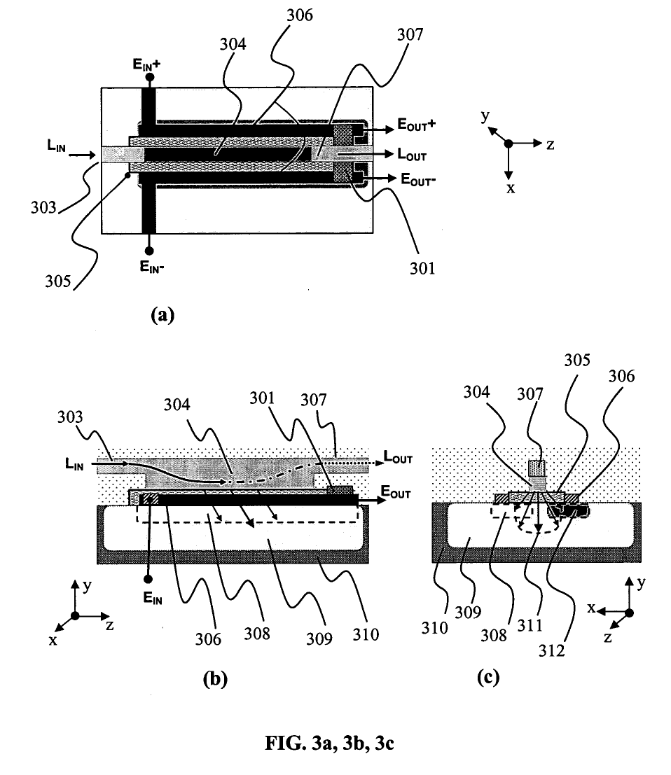

FIG. 3a to 3c are diagrams for three different views of the asymmetric multimode interference structure integrated with an electronic chip to realize either the high speed optical receiver or transmitter function in accordance with two exemplary embodiments of the present invention. Here, a highly confined asymmetric multimode interference optical wave guide coupling structure 304 such as in FIG. 2b is integrated with a conventional CMOS based optical to electrical or electrical to optical conversion device 309, which consists of depletion regions 308 and 312. In such a case, the semiconductor junction device thus formed 309 may be operated as a photodetection device (reverse electronic bias) or as an optical modulation device (forward bias, carrier induced optical modulation). The natural distribution of optical power coupled to the conversion device is gradual (nearly exponential) along the length of the optical-electrical coupling structure, reducing the onset of optical absorption saturation in the case of high optical power densities. An electrically terminated 301 traveling wave electrical coplanar strip line 306 enables high speed operation if the speed of the optical signal along the length of the multimode coupling region is comparable to the speed of the induced (detection) or applied (optical modulation) electrical signal. For the transmitter function, a constant input optical power is typically used for the input light 303, and the optical absorption in the substrate conversion device 309 is modulated by an applied electrical signal at input to the electrical terminal structure 306 , leading to modulation of the output optical signal at optical output guide 307. For the optical receiver function, a typically fixed electrical signal is applied as a bias at the input to the electrical terminal structure 306, and the input optical signal is directly converted to an electrical output signal at 301 through optical to electrical absorption. The optical absorption and modulation in the substrate layer can be achieved by any of a number of alternative techniques well known to one skilled in the relevant art.

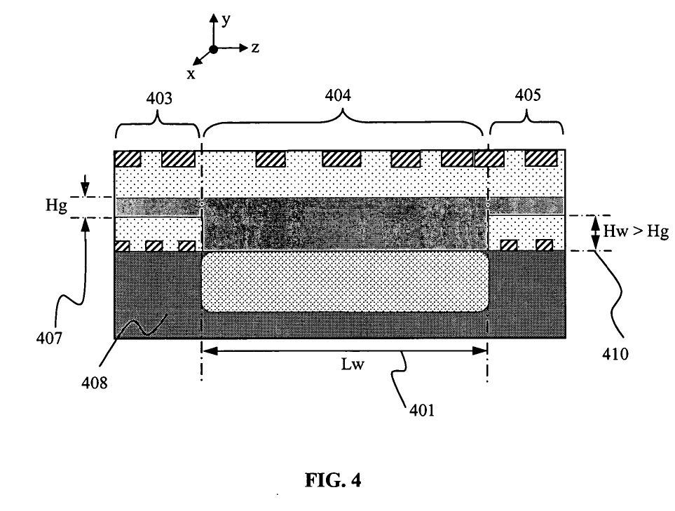

Referring now to FIG. 4, there is shown a cross sectional diagram of the asymmetric multimode interference structure in an optical to electrical coupling mode where the spacing between the optical guide and the electronic layer is increased in accordance with an exemplary embodiment of the present invention. Here, a thicker multimode interference coupling layer results in increased spacing 410 between the input and output single mode optical guides 403, 405 and the substrate/electrical layer 408 and serves to reduce the optical scatter and absorption losses associated with electronic and other structures on the substrate surface. A multimode section of 1.5 times the single mode guide thickness results in a good balance between excess optical loss from multimode to single mode transfer at the output of the multimode section, and reduced optical scatter losses from the electronic substrate circuitry elements. For this case, the presence of the high optical effective index mismatch between substrate 408 and multimode coupling material layer 410 is critical to achieve low excess loss asymmetric multimode interference coupling operation.

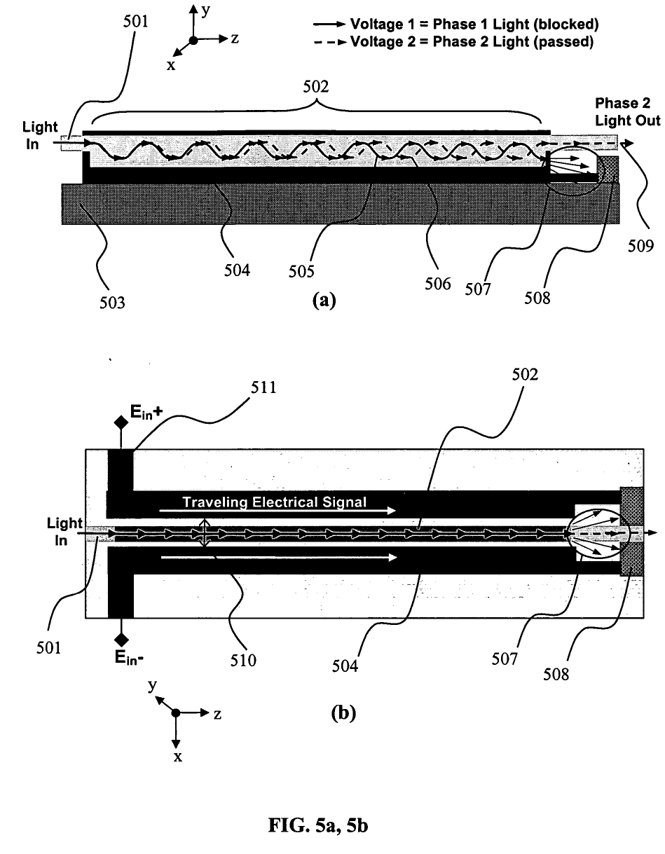

Referring now to FIGS. 5a and 5b, there are shown two diagrams corresponding to two views of the asymmetric multimode interference structure in an electrical to optical coupling mode whereby the optical output light is modulated by an electrical signal in accordance with an exemplary embodiment of the present invention. Specifically, this is an embodiment that serves the electrical to optical transmitter function. Here, unit coupling length of the asymmetric multimode interference structure 502 is modulated by an electrical signal 511 through any of a number of electro-optical effects well known to one skilled in the relevant art. The optical output signal is a maximum when the length of the coupling region is equal to an integer number of unit lengths for a given applied electrical signal. The output optical signal is a minimum when the coupling region length is an odd integer number of half-unit lengths (e.g. 18.5, 19.5, etc . . . ) at a different applied electrical signal level. The structure employs a matched velocity traveling wave electrode design in a fashion similar to that discussed in FIG. 3.

Referring to FIG. 6, there is seen a cross sectional diagram of a specific configuration of the structure of FIG. 1b or FIG. 4 whereby optical-electrical coupling is localized and/or enhanced by the use of an isolated substrate layer in accordance with an exemplary embodiment of the present invention. Vertical localization of the index and/or absorption modulated substrate layer 608 is achieved by insertion of a low optical index and electrically isolated layer 607 between the substrate surface layer and the substrate main body 605. An example of a typical implementation of such a structure would be by the use of silicon on insulator substrate, but can be achieved by any of a host of alternative methods well known to one skilled in the relevant art. The presence of the high effective index contrast between the substrate surface layer 608 and the substrate insulating layer 607 confines the optical-electrical conversion to the thin surface layer, typically with optically resonant effects that enhance the conversion process.

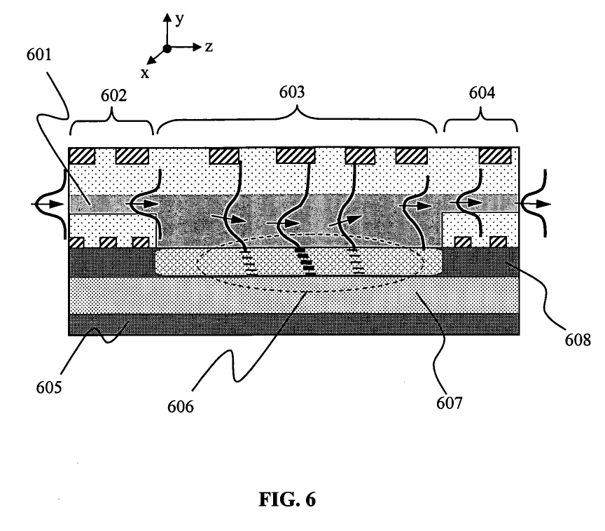

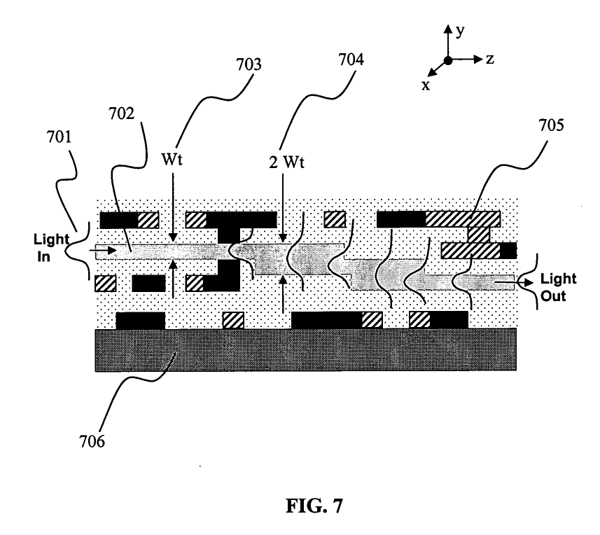

Referring now to FIG. 7 is a cross sectional diagram of the asymmetric multimode interference structure in an optical to optical coupling mode whereby different optical layers can be connected over a relatively short distance in accordance with an exemplary embodiment of the present invention. Input optical signal at 701 goes through asymmetric multimode interference over one half the characteristic multimode oscillation unit length resulting in low loss coupling of the optical signal into the output wave guide located between various electrical interconnect layers 705. By series cascade of at least two asymmetric multimode structures, the optical signal can couple between two separate optical layers over a fairly short distance as shown in FIG. 7. This embodiment serves as the optical equivalent to the “via” used for connecting electrical circuit layers. The thickness 704 of the multimode coupling region is chosen as equal or nearly equal to twice the wave guide core thickness 703. The thickness of the interconnecting single mode wave guide 703 is chosen so as to be equal or very near to the “single mode” thickness requirement at the optical wavelength of the optical signal. This ensures first and second order optical modes in the multimode interference region to be near equally filled and a minimum of excess optical loss to be incurred.

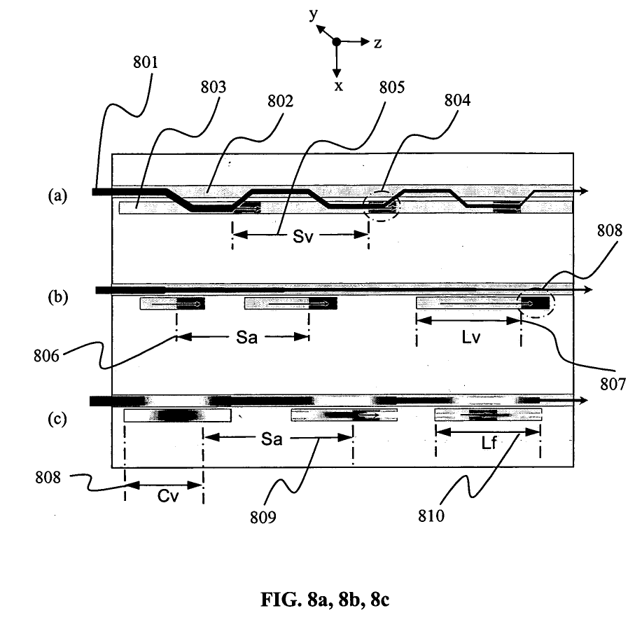

FIG. 8a to 8c are top view diagrams of various symmetric evanescent or directional optical coupler schemes for the purpose of optical to electrical signal equalization over a series cascade of a plurality of asymmetric multimode interference structures integrated as partially coupling optical receivers commonly referred to as optical taps in accordance with an exemplary embodiment of the present invention. Referring now to FIG. 8a, with light entering the coupler input guide 802, the multimode interference coupler taps are inserted at strategic points on the target coupler guide 803 so as to absorb a smaller fraction of the light for the first tap in the series cascade of taps 804 in target guide 803, and a progressively higher fraction of light for each successive tap in the series. This is due to the spatial oscillation of light that occurs between the two laterally coupled guides. This way, each tap device will “see” the same optical signal power, and the optical to electrical conversion will be equal for each tap device. Equal signal translates to a matched frequency response for the tap devices. To assure equal optical signal to each tap, the coupling fraction at each tap is chosen as:
Cₙ=1/(N−n+1)n=[1, 2 . . . N]
Where Cₙis the coupling fraction for tap n in the series, and N is the total number of taps.

In another case, the successive coupling fractions can be chosen in a way that creates a conversion delay for the first tap that is exceeds the transit time between the first tap and the last tap in the series. In this fashion, the tap signals can be synchronized in time such that the conversion signal becomes valid for all taps at the same point in time. This is desirable for applications such as clock distribution.

Referring now to FIG. 8b, the evanescent coupler can be segmented to allow more arbitrary placement 806 of tap devices 808 regardless of the desired coupling fraction. These tap devices will be chosen to terminate any optical signal that is injected. Termination occurs by increasing the coupling fraction to near unity through any of a number of techniques discussed previously for FIG. 1b. The segmented target guides are varied in length 807 to achieve the desired coupling fraction for each tap in the series cascade.

Referring now to FIG. 8c, a combination of the first two approaches of FIG. 8a and FIG. 8b is shown. Here, the tap structures are of the non-terminating type. The lengths of the segmented target wave guide coupler sections are equal to twice the coupling length of the evanescent coupler such that any light that couples to the target guide section that is not collected is transferred back to the input coupler guide. Adjusting the gap between the guides determines the coupling length. The non-terminating taps are placed at different points 808 along the length of the fixed length 810 target coupler segments to achieve the desired coupled signal for each tap.

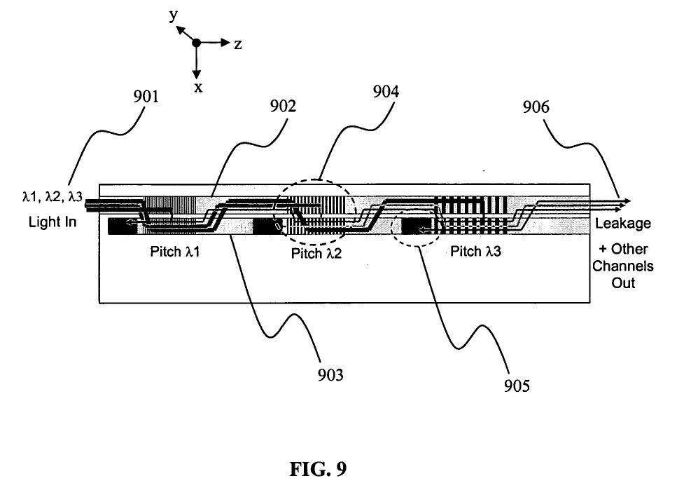

FIG. 9 is a top view diagram of a wavelength selective scheme based on integration of the asymmetric multimode interference structure with grating assisted wave guide directional couplers for the purpose of wavelength division multiplexing or demultiplexing in accordance with an exemplary embodiment of the present invention. Here, wavelength selective elements such as Bragg gratings 904 are integrated to facilitate the wavelength division multiplexing function. In the figure, three optical signals at different wavelengths 901 enter the directional coupler input guide 902 . The coupler causes all optical signals to spatially oscillate between the two wave guides. Each grating 904 is tuned to a different wavelength range, such that when an optical signal in that wavelength range reaches the grating, it is reflected back into an optically terminated multimode interference optical tap device 905.

Although the figure exhibits the use of asymmetric multimode interference tap (optical to electrical coupling) devices 905, any of a number of electrical to optical transmitter device embodiments of the invention can also be in their place. A segmented version of the coupler would be used, whereby source light at various wavelengths would be injected into the modulator, and the modulated light then coupled to the output guide via the same evanescent grating assisted coupling mechanism. The modulated optical signal would propagate in an opposite direction to the initial input direction into the asymmetric multimode interference modulator structure.

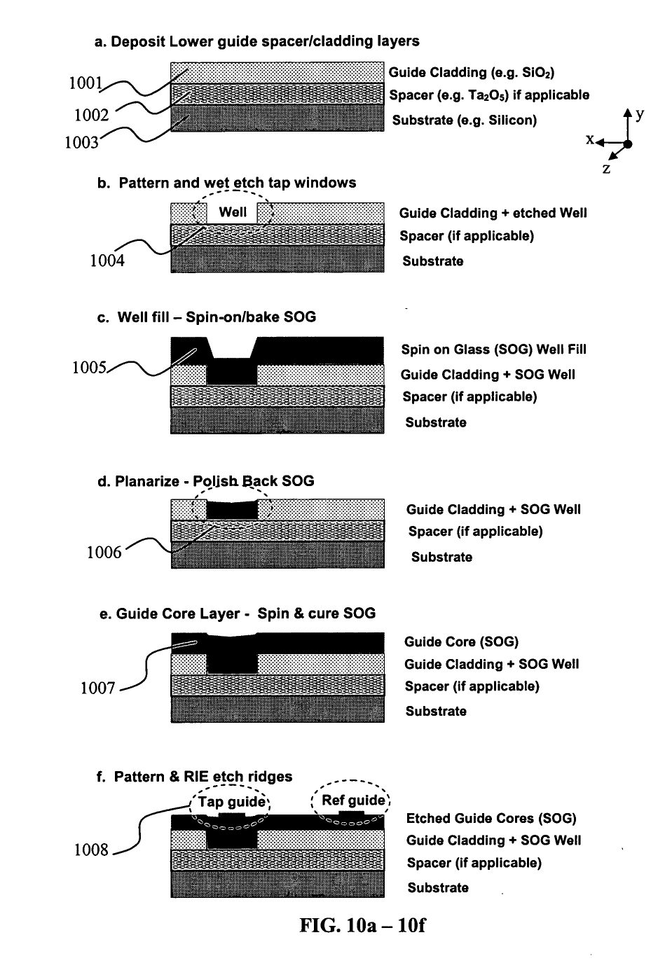

FIG. 10a to 10f is a series of cross sectional diagrams illustrating example process steps to fabricate the asymmetric multimode interference structure in a method of manufacture example for an asymmetric multimode interference wave guide coupler device that is in accordance with an exemplary embodiment of the present invention.

In FIG. 10a, a semiconductor chip substrate 1003, such as silicon, is coated with a spacer material 1002 of an index that is typically near the geometric mean of the substrate index and the wave guide index. For example, this layer can also consist of a multi-layer structure (not shown) to achieve the desired optical and electrical coupling properties, such as enhanced coupling fraction, and/or wavelength selective coupling. In this case, a simple layer of Tantalum Pentoxide is chosen as the spacer layer 1002. The top surface of the spacer layer 1002 is then coated with a low optical refractive index material, such as silicon dioxide, which will constitute the wave guide lower cladding 1003. The coatings can be achieved by any of a number of ways already available in the integrated electronic circuit fabrication industry. Some methods are sputtering, evaporation, chemical vapor deposition, and spin-on (Sol-Gel).

In FIG. 10b, the lower cladding is patterned and etched by standard lithographic and etch methods available in the integrated circuit industry. These form the offset multimode interference coupling layers or “wells” 1004 of the asymmetric multimode interference structures.

In FIG. 1c, a wave guide core material 1005 is deposited to fill the wells 1004 etched in the previous step. The core material typically has a higher optical index relative to the cladding material so as to achieve positive index wave guides. Spin-on materials are ideal for this step, as they feature high step coverage and well filling capabilities.

In FIG. 10d, the 1005 core material layer is surface planarized down to the surface of the cladding layer 1001 to planarize the filled well 1006 by any of a number of techniques. Direct chemical mechanical polishing may be used. Another technique available in the industry is the etch-back techniques, whereby a lower temperature polymer material that has the same etch properties as the core material is deposited and “reflowed”. The resulting planar surface is then etched down until the lower cladding is exposed. The steps in FIG. 10c and FIG. 10d may be repeated as necessary until sufficient planarization of the surface is achieved.

In FIG. 10e, another layer of wave guide core material 1007 is deposited to a thickness equal to the desired wave guide thickness to achieve single mode operation in the operating optical wavelength range.

In FIG. 10f, the lateral optical confinement of the wave guide is defined by patterning and etching the wave guide sidewalls 1008. The depth of etching determines the degree of optical mode confinement as previously discussed in FIG. 2a and FIG. 2b. Typically the lateral mode confinement is chosen to support a single lateral mode of optical propagation. Thus, with deeper etching, the width of the guide becomes reduced. A top layer of cladding material (lower index) may be applied to optically isolate the wave guide from subsequent deposited layers that can be optical interconnect and/or electrical interconnect layers.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims'equivalents rather than the foregoing description.

1. A monolithic integrated photonic interconnect device, comprising:
an optical layer having an input end and an output end, capable of conveying light between the input end and the output end;
a semiconductor substrate layer comprising an integrated optical-electronic device and electronic circuitry operationally connected to the integrated optical-electronic device; and
an optical coupling device disposed between, and operationally connected to, the optical layer and the optical-electronic device.

2. The monolithic integrated photonic interconnect device of claim 1, wherein the integrated optical-electronic device is able to generate light, detect light, amplify light or otherwise modulate amplitude or phase of light.

3. The monolithic integrated photonic interconnect device of claim 1, wherein the integrated optical-electronic device is a traveling wave type photodetector.

4. The monolithic integrated photonic interconnect device of claim 1, wherein the optical coupling device is an asymmetric multimode interference coupler.

5. The monolithic integrated photonic interconnect device of claim 4, where the optical layer comprises:
a first single mode transport channel wave guide portion operationally connected to the input end of the optical layer and the optical coupling device;
a second single mode transport channel wave guide portion operationally connected to the output end of the optical layer and the optical coupling device;
wherein the first and second single mode channel wave guide portions and the optical coupling device have substantially the same layer dimensions.

6. The monolithic integrated photonic interconnect device of claim 2, wherein the substrate layer further comprises a substrate bulk layer and the optical-electronic device comprises an optically resonant conversion layer that is substantially optically and electrically isolated from the substrate bulk layer, for substantially vertically localizing the optical-electrical conversion of the optical-electronic device and substantially enhancing conversion efficiency of the optical-electronic device.

7. The monolithic integrated photonic interconnect device of claim 5, further comprising:
a spacer structure positioned between the asymmetric multimode section and the optical-electrical device, for controlling coupling strength, polarization sensitivity or coupling spectral characteristics.

8. The monolithic integrated photonic interconnect device of claim 2, wherein the optical-electronic device comprises an optical index or phase velocity multimode coupling region adapted to adjust the output coupling loss in response to an applied electrical signal.

9. A monolithic integrated photonic interconnect device, comprising:
an optical layer having an input end and an output end, capable of conveying light between the input end and the output end;
a semiconductor substrate layer comprising a plurality of integrated optical-electronic devices and electronic circuitry operationally connected to each integrated optical-electronic device; and
a plurality of optical coupling devices, with at least one optical coupling device disposed between, and operationally connected to, the optical layer and each optical-electronic device.

10. The monolithic integrated photonic interconnect device of claim 9, wherein the optical-electronic devices and associated optical coupling devices are arranged in a series cascade and adapted to perform optical to electrical signal equalization.

11. The monolithic integrated photonic interconnect device of claim 9, wherein at least one optical coupling device further comprises a wave guide grating assisted coupler adapted to selectively direct light of a particular wavelength to the optical-electronic device operationally connected to the optical coupling device.
